(19) United States
(12) Patent Application Publication
(10) Pub. No.: US 2025/0355856 A1
(43) Pub. Date: Nov. 20, 2025

(54) TIMESTAMP-BASED APPROACH TO DETECTING STALE VALUES IN A CACHE

(71) Applicant: Dropbox, Inc., San Francisco, CA (US)

(72) Inventors: Lihao He, San Jose, CA (US); Yu-Wun Wang, South San Francisco, CA (US); Ganesh Prasad Rapolu, Mountain House, CA (US); Preslav Le, Belmont, CA (US)

(21) Appl. No.: 18/667,953

(22) Filed: May 17, 2024

(51) Int. Cl. G06F 16/23; G06F 16/2455

(52) U.S. Cl. CPC G06F 16/2322; G06F 16/24552

(57) ABSTRACT

Systems and methods are disclosed herein for enabling consistent caching. The disclosed approach enables consistent caching by maintaining a timestamp that tracks an upper bound for the most recent observed write attempt to any key, regardless of whether the write attempt was successful or unsuccessful. When a server attempts to read a value of a key, it compares the upper bound timestamp of the key to a read timestamp of the key. The read timestamp is stored in the cache and represents a time at which the key was most recently read. If the upper bound timestamp is after the read timestamp, the cache is stale, so the server retrieves the value of the key from data storage rather than the cache. If the upper bound timestamp is before the read timestamp, the server retrieves the value of the key from the cache.

### TECHNICAL FIELD

The disclosed embodiments generally relate to database technologies, and particularly to systems and methods for consistent caching.

### BACKGROUND

Data storage systems often rely on caching to handle large amounts of requests. Though useful in reducing the demand on data storage systems, caching can sometimes have problems with consistency, where a cache and a storage system have inconsistent values for the same key. For example, if a server orchestrating a write request crashes in between writing a value to the storage system and writing the value to the cache, the server may fail to update the cache, leaving stale data in the cache for the next time it is read.

### SUMMARY

Systems and methods are disclosed herein for enabling consistent caching, among other things. The proposed approach enables consistent caching by maintaining a timestamp that tracks an upper bound for the most recent observed write attempt to any key, regardless of whether the write attempt was successful or unsuccessful. When a server attempts to read a value of a key, it compares the upper bound timestamp of the key to a read timestamp of the key. The read timestamp is stored in the cache and represents a time at which the key was most recently read. If the upper bound timestamp is after the read timestamp, the cache is stale, so the server retrieves the value of the key from data storage rather than the cache. If the upper bound timestamp is before the read timestamp, the server retrieves the value of the key from the cache. The systems and methods disclosed herein ensure that data provided by the server, whether from the key value store or from the associated cache, is the most up to date data available. The server may thus rely on the cache to help serve requests, reducing the demand on the key-value store and enabling processing of a high amount of read queries per second (QPS).

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 shows a diagram of a system environment of a content management system and a collaborative content management system according to one embodiment.

FIG. 2 shows a block diagram of components of a client device, according to one example embodiment.

FIG. 3 shows a block diagram of a content management system, according to one example embodiment.

FIG. 4 shows a block diagram of a collaborative content management system, according to one example embodiment.

FIG. 5A is a flow chart that illustrates an example process for reading a value of a key from a key-value store using a cache, according to one example embodiment.

FIG. 5B is a flow chart that illustrates an example process for writing a value to a key in a key-value store, according to one example embodiment.

FIG. 6 is an interaction diagram illustrating a write process, according to one example embodiment.

FIG. 7A shows a read process where a cache is not stale with respect to a key-value store, according to one example embodiment.

FIG. 7B shows a read process where cache 332 is stale with respect to content storage 318, according to one example embodiment.

FIG. 7C shows a read process with a cache miss, according to one example embodiment.

The figures depict various embodiments of the present invention for purposes of illustration only. One skilled in the art will readily recognize from the following description that other alternative embodiments of the structures and methods illustrated herein may be employed without departing from the principles of the invention described herein.

### DETAILED DESCRIPTION

### System Overview

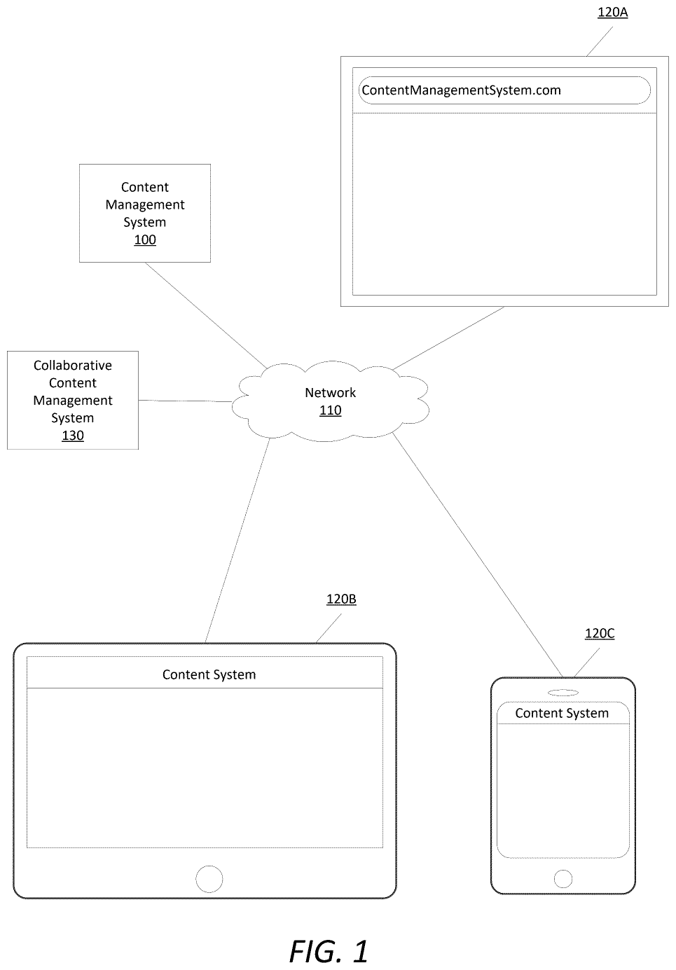

FIG. 1 shows a system environment including content management system 100, collaborative content management system 130, and client devices 120a, 120b, and 120c (collectively or individually “120”). Content management system 100 provides functionality for sharing content items with one or more client devices 120 and synchronizing content items between content management system 100 and one or more client devices 120.

The content stored by content management system 100 can include any type of content items, such as documents, spreadsheets, collaborative content items, text files, audio files, image files, video files, webpages, executable files, binary files, placeholder files that reference other content items, etc. In some implementations, a content item can be a portion of another content item, such as an image that is included in a document. Content items can also include collections, such as folders, namespaces, playlists, albums, etc., that group other content items together. The content stored by content management system 100 may be organized in one configuration in folders, tables, or in other database structures (e.g., object oriented, key/value etc.).

In one embodiment, the content stored by content management system 100 includes content items created by using third party applications, e.g., word processors, video and image editors, database management systems, spreadsheet applications, code editors, and so forth, which are independent of content management system 100.

In some embodiments, content stored by content management system 100 includes content items, e.g., collaborative content items, created using a collaborative interface provided by collaborative content management system 130. In various implementations, collaborative content items can be stored by collaborative content item management system 130, with content management system 100, or external to content management system 100. A collaborative interface can provide an interactive content item collaborative platform whereby multiple users can simultaneously create and edit collaborative content items, comment in the collaborative content items, and manage tasks within the collaborative content items.

Users may create accounts at content management system 100 and store content thereon by sending such content from client device 120 to content management system 100. The content can be provided by users and associated with user accounts that may have various privileges. For example, privileges can include permissions to: see content item titles, see other metadata for the content item (e.g. location data, access history, version history, creation/modification dates, comments, file hierarchies, etc.), read content item contents, modify content item metadata, modify content of a content item, comment on a content item, read comments by others on a content item, or grant or remove content item permissions for other users.

Client devices 120 communicate with content management system 100 and collaborative content management system 130 through network 110. The network may be any suitable communications network for data transmission. In one embodiment, network 110 is the Internet and uses standard communications technologies and/or protocols. Thus, network 110 can include links using technologies such as Ethernet, 802.11, worldwide interoperability for microwave access (WiMAX), 3G, 4G, digital subscriber line (DSL), asynchronous transfer mode (ATM), InfiniBand, PCI Express Advanced Switching, etc. Similarly, the networking protocols used on network 110 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over network 110 can be represented using technologies and/or formats including the hypertext markup language (HTML), the extensible markup language (XML), JavaScript Object Notation (JSON), etc. In addition, all or some of links can be encrypted using conventional encryption technologies such as the secure sockets layer (SSL), transport layer security (TLS), virtual private networks (VPNs), Internet Protocol security (IPsec), etc. In another embodiment, the entities use custom and/or dedicated data communications technologies instead of, or in addition to, the ones described above.

In some embodiments, content management system 100 and collaborative content management system 130 are combined into a single system. The system may include one or more servers configured to provide the functionality discussed herein for the systems 100 and 130.

### Client Device

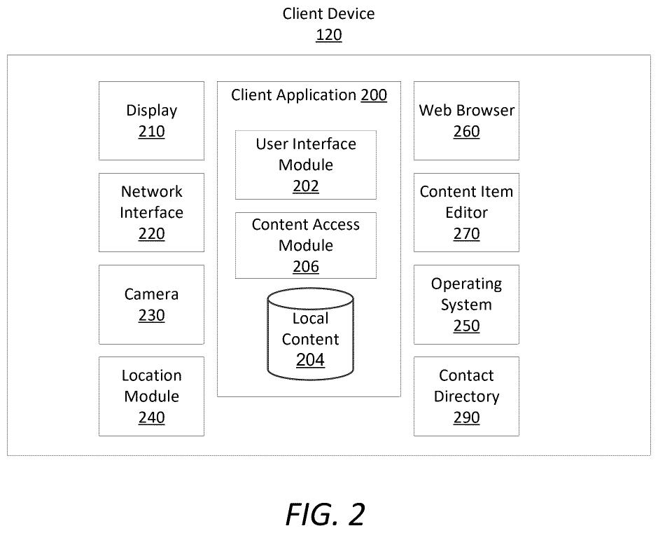

FIG. 2 shows a block diagram of the components of a client device 120 according to one embodiment. Client devices 120 generally include devices and modules for communicating with content management system 100 and a user of client device 120. Client device 120 includes display 210 for providing information to the user, and in certain client devices 120 includes a touchscreen. Client device 120 also includes network interface 220 for communicating with content management system 100 via network 110. There are additional components that may be included in client device 120 but that are not shown, for example, one or more computer processors, local fixed memory (RAM and ROM), as well as optionally removable memory (e.g., SD-card), power sources, and audio-video outputs.

In certain embodiments, client device 120 includes additional components such as camera 230 and location module 240. Location module 240 determines the location of client device 120, using, for example, a global positioning satellite signal, cellular tower triangulation, or other methods. Location module 240 may be used by client application 200 to obtain location data and add the location data to metadata about a content item.

Client devices 120 maintain various types of components and modules for operating the client device and accessing content management system 100. The software modules can include operating system 250 or a collaborative content item editor 270. Collaborative content item editor 270 is configured for creating, viewing and modifying collaborative content items such as text documents, code files, mixed media files (e.g., text and graphics), presentations or the like. Operating system 250 on each device provides a local file management system and executes the various software modules such as content management system client application 200 and collaborative content item editor 270. A contact directory 290 stores information on the user's contacts, such as name, telephone numbers, company, email addresses, physical address, website URLs, and the like.

Client devices 120 access content management system 100 and collaborative content management system 130 in a variety of ways. Client device 120 may access these systems through a native application or software module, such as content management system client application 200. Client device 120 may also access content management system 100 through web browser 260. As an alternative, the client application 200 may integrate access to content management system 100 with the local file management system provided by operating system 250. When access to content management system 100 is integrated in the local file management system, a file organization scheme maintained at the content management system is represented at the client device 120 as a local file structure by operating system 250 in conjunction with client application 200.

Client application 200 manages access to content management system 100 and collaborative content management system 130. Client application 200 includes user interface module 202 that generates an interface to the content accessed by client application 200 and is one means for performing this function. The generated interface is provided to the user by display 210. Client application 200 may store content accessed from a content storage at content management system 100 in local content 204. While represented here as within client application 200, local content 204 may be stored with other data for client device 120 in non-volatile storage. When local content 204 is stored this way, the content is available to the user and other applications or modules, such as collaborative content item editor 270, when client application 200 is not in communication with content management system 100. Content access module 206 manages updates to local content 204 and communicates with content management system 100 to synchronize content modified by client device 120 with content maintained on content management system 100, and is one means for performing this function. Client application 200 may take various forms, such as a stand-alone application, an application plug-in, or a browser extension.

### Content Management System

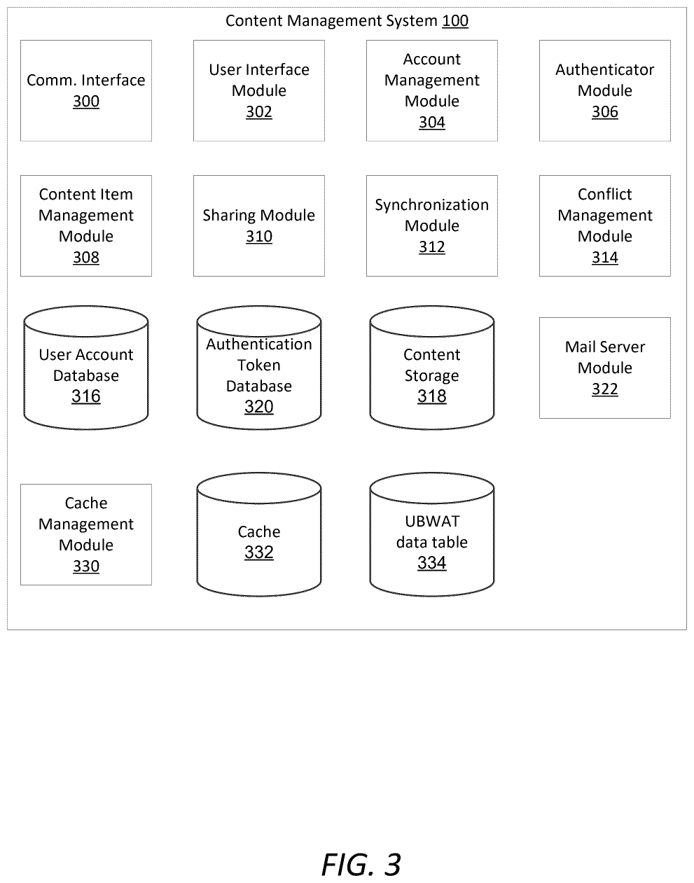

FIG. 3 shows a block diagram of the content management system 100 according to one embodiment. To facilitate the various content management services, a user can create an account with content management system 100. The account information can be maintained in user account database 316, and is one means for performing this function.

User account database 316 can store profile information for registered users. In some cases, the only personal information in the user profile is a username and/or email address. However, content management system 100 can also be configured to accept additional user information, such as password recovery information, demographics information, payment information, and other details. Each user is associated with a userID and a username. For purposes of convenience, references herein to information such as collaborative content items or other data being “associated” with a user are understood to mean an association between a collaborative content item and either of the above forms of user identifier for the user. Similarly, data processing operations on collaborative content items and users are understood to be operations performed on derivative identifiers such as collaborativeContentItemID and userIDs. For example, a user may be associated with a collaborative content item by storing the information linking the userID and the collaborativeContentItemID in a table, file, or other storage formats. For example, a database table organized by collaborativeContentItemIDs can include a column listing the userID of each user associated with the collaborative content item. As another example, for each userID, a file can list a set of collaborativeContentItemID associated with the user. As another example, a single file can list key values pairs such as <userID, collaborativeContentItemID> representing the association between an individual user and a collaborative content item. The same types of mechanisms can be used to associate users with comments, threads, text elements, formatting attributes, and the like.

User account database 316 can also include account management information, such as account type, e.g. free or paid; usage information for each user, e.g., file usage history; maximum storage space authorized; storage space used; content storage locations; security settings; personal configuration settings; content sharing data; etc. Account management module 304 can be configured to update and/or obtain user account details in user account database 316. Account management module 304 can be configured to interact with any number of other modules in content management system 100.

An account can be used to store content items, such as collaborative content items, audio files, video files, etc., from one or more client devices associated with the account. Content items can be shared with multiple users and/or user accounts. In some implementations, sharing a content item can include associating, using sharing module 310, the content item with two or more user accounts and providing for user permissions so that a user that has authenticated into one of the associated user accounts has a specified level of access to the content item. That is, the content items can be shared across multiple client devices of varying type, capabilities, operating systems, etc. The content items can also be shared across varying types of user accounts.

Individual users can be assigned different access privileges to a content item shared with them, as discussed above. In some cases, a user's permissions for a content item can be explicitly set for that user. A user's permissions can also be set based on: a type or category associated with the user (e.g., elevated permissions for administrator users or manager), the user's inclusion in a group or being identified as part of an organization (e.g., specified permissions for all members of a particular team), and/or a mechanism or context of a user's accesses to a content item (e.g., different permissions based on where the user is, what network the user is on, what type of program or API the user is accessing, whether the user clicked a link to the content item, etc.). Additionally, permissions can be set by default for users, user types/groups, or for various access mechanisms and contexts.

In some implementations, shared content items can be accessible to a recipient user without requiring authentication into a user account. This can include sharing module 310 providing access to a content item through activation of a link associated with the content item or providing access through a globally accessible shared folder.

The content can be stored in content storage 318, which is one means for performing this function. Content storage 318 can be a storage device, multiple storage devices, or a server. Alternatively, content storage 318 can be a cloud storage provider or network storage accessible via one or more communications networks. The cloud storage provider or network storage may be owned and managed by the content management system 100 or by a third party. In one configuration, content management system 100 stores the content items in the same organizational structure as they appear on the client device. However, content management system 100 can store the content items in its own order, arrangement, or hierarchy.

Content storage 318 can also store metadata describing content items, content item types, and the relationship of content items to various accounts, folders, or groups. The metadata for a content item can be stored as part of the content item or can be stored separately. In one configuration, each content item stored in content storage 318 can be assigned a system-wide unique identifier.

In one embodiment, content storage 318 may be a distributed system that stores data as key-value pairs in tables distributed across multiple nodes, where a node may be a system or a device (such as a computer or a server) that stores a portion of the data. In one embodiment, a data table (or table) is a collection of key-value pairs (may also be referred to as entries) that are stored in one node or distributed across multiple nodes. A set of related tables may be grouped as a family of tables.

Content storage 318 can decrease the amount of storage space required by identifying duplicate files or duplicate segments of files. Instead of storing multiple copies of an identical content item, content storage 318 can store a single copy and then use a pointer or other mechanism to link the duplicates to the single copy. Similarly, content storage 318 stores files using a file version control mechanism that tracks changes to files, different versions of files (such as a diverging version tree), and a change history. The change history can include a set of changes that, when applied to the original file version, produces the changed file version.

Content storage 318 may further decrease the amount of storage space required by deleting content items based on expiration time of the content items. An expiration time for a content item may indicate that the content item is no longer needed after the expiration time and may therefore be deleted. Content storage 318 may periodically scan through the content items and compare expiration time with current time. If the expiration time of a content item is earlier than the current time, content storage 318 may delete the content item from content storage 318.

Content management system 100 automatically synchronizes content from one or more client devices, using synchronization module 312, which is one means for performing this function. The synchronization is platform agnostic. That is, the content is synchronized across multiple client devices 120 of varying type, capabilities, operating systems, etc. For example, client application 200 synchronizes, via synchronization module 312 at content management system 100, content in client device 120's file system with the content in an associated user account on system 100. Client application 200 synchronizes any changes to content in a designated folder and its sub-folders with the synchronization module 312. Such changes include new, deleted, modified, copied, or moved files or folders. Synchronization module 312 also provides any changes to content associated with client device 120 to client application 200. This synchronizes the local content at client device 120 with the content items at content management system 100.

Conflict management module 314 determines whether there are any discrepancies between versions of a content item located at different client devices 120. For example, when a content item is modified at one client device and a second client device, differing versions of the content item may exist at each client device. Synchronization module 312 determines such versioning conflicts, for example by identifying the modification time of the content item modifications. Conflict management module 314 resolves the conflict between versions by any suitable means, such as by merging the versions, or by notifying the client device of the later-submitted version.

A user can also view or manipulate content via a web interface generated by user interface module 302. For example, the user can navigate in web browser 260 to a web address provided by content management system 100. Changes or updates to content in content storage 318 made through the web interface, such as uploading a new version of a file, are synchronized back to other client devices 120 associated with the user's account. Multiple client devices 120 may be associated with a single account and files in the account are synchronized between each of the multiple client devices 120.

Content management system 100 includes communications interface 300 for interfacing with various client devices 120, and with other content and/or service providers via an Application Programming Interface (API), which is one means for performing this function. Certain software applications access content storage 318 via an API on behalf of a user. For example, a software package, such as an app on a smartphone or tablet computing device, can programmatically make calls directly to content management system 100, when a user provides credentials, to read, write, create, delete, share, or otherwise manipulate content. Similarly, the API can allow users to access all or part of content storage 318 through a web site.

In some embodiments, content management system 100 relies on cache 332 to serve read requests made to content storage 318. Cache 332 stores a copy of a subset of data from content storage 318. For example, where content storage 318 is a key-value store, cache 332 stores a copy of a subset of key-value pairs from content storage 318. Cache 332 holds less data than content storage 318, meaning that if data is stored in cache 332, it may be accessed more quickly than the same data stored in content storage 318. Cache 332 may hold the data from content storage 318 that is most frequently or most recently accessed by content management system 100.

Cache 332 stores a read timestamp for each data point (e.g., key-value pair) in cache 332. The read timestamp is a timestamp associated with a value of a key. The read timestamp may indicate the time at which the value of the key was last read from content storage 318 and subsequently added to cache 332. For example, when content management system 100 makes a request to the cache and gets a cache miss (indicating that the key does not exist in the cache), content management system 100 reads the value of the key from the key-value store. The time at which this read is done is the read timestamp for the key. In some embodiments, the key-value store may provide the read timestamp to content management system 100. In other embodiments, content management system 100 may generate a read timestamp upon retrieval of the value from the key-value store. Content management system 100 may update the read timestamp upon retrieving the value of the key from the key-value store or upon adding the value of the key to cache 332, regardless of whether the value has changed. The read timestamp is greater than or equal to a commit timestamp. The commit timestamp represents the time at which the value was written to the key in content storage 318. If a key is read a few minutes apart without a write to the key in between, the commit timestamp for the key will be the same for both reads, and the read timestamp for the second read will be greater than the read timestamp for the first read.

Content management system 100 may use cache 332 to respond to frequent or recent requests more quickly and, as follows, reduce the demand on content storage 318. For example, content management system 100 may receive a request from a client (e.g., though communications interface 300) to read a value of a key in the key-value store. Content management system 100 checks to see if the key exists in cache 332. If content management system 100 receives a response from cache 332, indicating that the key exists in cache 332 (a cache “hit”), content management system 100 retrieves the value of the key from cache 332 and provides the value of the key to the client through communications interface 300. In the cache hit situation, content management system 100 avoids having to retrieve the value of the key from content storage 318. As content storage 318 holds more data than cache 332 (and may consist of slower storage media), retrieving data from content storage 318 may be slower than retrieving data from cache 332. If content management system 100 does not receive a response from cache 332, indicating that the key does not exist in cache 332 (a cache “miss”), content management system 100 retrieves the value of the key from content storage 318 and provides the value of the key to the client through communications interface 300. In response to a cache miss, content management system 100 may add the key-value pair retrieved from content storage 318 to cache 332 for faster retrieval on a subsequent request. The data in cache 332 may be periodically cleared such that the data set in cache 332 remains small; this ensures faster access to the data. In some embodiments, cache 332 may exist outside of content management system 100.

Cache management module 330 manages cache 332 and content storage 318. Cache management module 330 facilitates read and write requests to content storage 318, updates cache 332 with values from content storage 318, and clears cache 332 periodically. Cache management module 330 maintains consistent caching, ensuring that the values stored in cache 332 are not stale with respect to the values stored in content storage 318. Cache management module 330 maintains consistent caching by tracking upper bound write attempt timestamps (UBWATs) for keys in cache 332. In some embodiments, cache management module 330 may exist as a server outside of content management system 100.

Cache management module 330 maintains an upper bound write attempt timestamp (UBWAT) that tracks an upper bound for the most recent observed write attempt to a key. In response to receiving a write attempt to a key from communications interface 300 (e.g., from a client through an API), cache management module 330 records the timestamp of the write attempt. Cache management module 330 generates an UBWAT for the key such that the UBWAT is greater than or equal to the timestamp of the write attempt. In some embodiments, cache management module 330 may use the timestamp of the write attempt as the UBWAT. In other embodiments, cache management module 330 may add a buffer to the timestamp of the write attempt and use the buffered timestamp as the UBWAT. For example, cache management module 330 may receive a write attempt to a key at time t=9 seconds. Cache management module 330 may set the UBWAT for the key to t=9 seconds or may add a buffer of 0.1 seconds and set the UBWAT for the key to t=9.1 seconds.

While the UBWAT may be greater than the timestamp by any amount, an UBWAT too far in the future may inhibit caching. As described further below, cache management module 330 checks if cache 332 holds a stale value for a key based on a comparison between the UBWAT for the key and a read timestamp for the key. If the UBWAT is greater than the read timestamp, cache management module 330 determines that cache 332 holds a stale value. Thus, if cache management module 330 selects an UBWAT too far in the future, the UBWAT may always be after the read timestamp, inhibiting the use of cache 332. Cache management module 330 may select the buffer to be a default value (e.g., 0.1 seconds) or a dynamic value that changes based on demand to the cache. For example, if demand to cache 332 is high, cache management module 330 may select lower buffers, generating UBWATs closer to the timestamps of the write attempts. This increases the requests that get to cache 332, as more UBWATs will be before the read timestamps. If demand to the cache is low, cache management module 330 may select greater buffers, generating UBWATs further in the future from the timestamps of the write attempts. Cache management module 330 may select the buffer to be a value input by a client of client device 120. The UBWAT, or any timestamp (e.g., read timestamp, commit timestamp), may be a number that does not reflect the actual time but rather reflects the relationships between timestamps.

Cache management module 330 may track multiple UBWATs, each corresponding to a different key. For example, cache management module 330 may track a UBWAT of t=9.1 seconds for a key K and a UBWAT of t=9.5 seconds for a key L. In response to receiving a write attempt at t=10 seconds to update the value of key K, cache management module 330 may update the UBWAT for key K to t=10.1 seconds but not update the UBWAT for key L. Likewise, in response to receiving a write attempt at t=10.4 seconds to update the value of key L, cache management module 330 may update the UBWAT for key L to t=10.5 seconds but not update the UBWAT for key K.

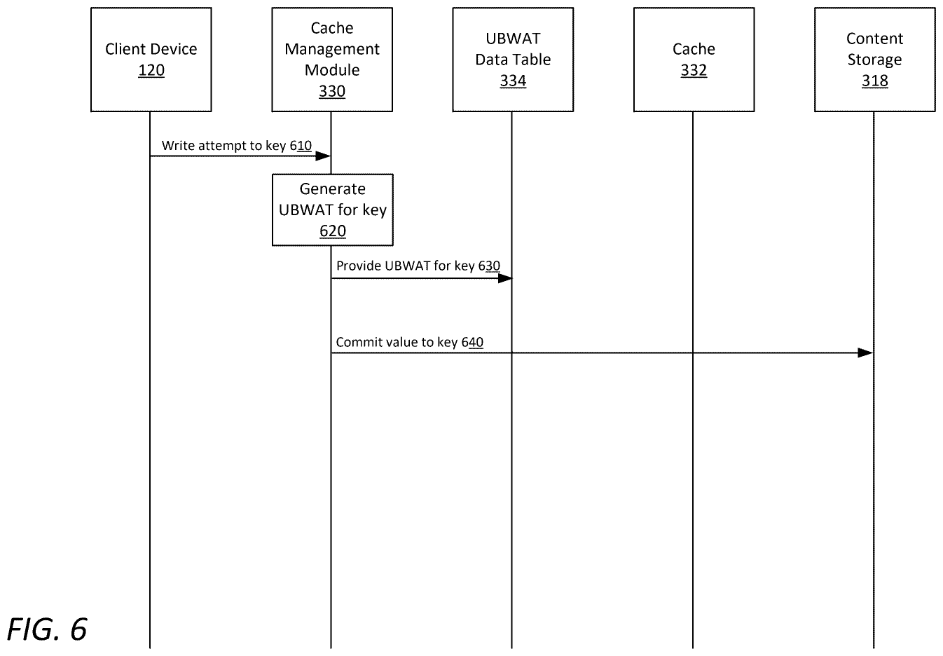

In response to generating or updating an UBWAT for the key, cache management module 330 stores the UBWAT in UBWAT data table 334 and commits the value to the key in content storage 318. UBWAT data table 334 may store keys in cache 332 along with their corresponding UBWATs. In some embodiments, UBWAT data table 334 may be a server that exists outside of content management system 100. Cache management module 330 generates an UBWAT for the key regardless of whether the write attempt to the key was successful (i.e., resulted in a commit to content storage 318). Further details of a write process are described with respect to FIG. 6.

FIG. 6 is an interaction diagram illustrating a write process, in accordance with some embodiments. The depicted process begins with cache management system 330 receiving, from client device 120 (through, e.g., communications interface 300), a write attempt to a key 610 in content storage 318. The write attempt is an attempt to write a value to the key. Cache management system 330 generates 620 an UBWAT for the key. Cache management system 330 provides the UBWAT for the key 630 to UBWAT data table 334. If the key already exists in UBWAT data table 334 with a corresponding UBWAT, this step may include updating the existing UBWAT with the newly generated UBWAT. If the key does not exist in UBWAT data table 334 with a corresponding UBWAT, this step may include adding the key to the UBWAT data table 334 with the newly generated UBWAT. Cache management system commits the value to the key 640, which updates the value of the key in content storage 318.

In some embodiments, cache management module 330 may receive a write attempt (e.g., from a client or a service) along with an attempt timestamp. The attempt timestamp represents a time at which cache management module 330 should complete the write by. If cache management module 330 is unable to commit the write to content storage 318 by the attempt timestamp, cache management module 330 fails the write. In response to the attempt timestamp being after the UBWAT for the key, cache management module 330 fails the write.

Returning to the discussion of cache management module 330, cache management module 330 checks if cache 332 holds a stale value for a key based on an UBWAT for the key. Cache management module 330 may check if cache 332 holds a stale value for the key in response to receiving a read request for the key from communications interface 300. Cache management module 330 obtains a read timestamp for the key from cache 332. Cache management module 330 obtains an UBWAT for the key from UBWAT data table 334. Cache management module 330 compares the UBWAT for the key to the read timestamp for the key. In response to the UBWAT being before the read timestamp, cache management module 330 determines that the value of the key held in cache 332 is not stale.

In response to the UBWAT being after the read timestamp, cache management module 330 determines that the value of the key held in cache 332 is stale. For example, say cache 332 holds key with value A with a read timestamp of t=8 seconds, indicating that the last time cache 332 was read was at t=8 seconds. At t-9 seconds, cache management module 330 may receive a write attempt to write a new value B to the key. Cache management module 330 may set the UBWAT for the key to t=9.1 seconds. Cache management module 330 writes the new value B to the key in content storage 318. If, at t=10 seconds, a client makes a request to read the value of the key, cache management module 330 compares the read timestamp of t=8 seconds to the UBWAT of t=9.1 seconds. As the UBWAT is after the read timestamp, the value of the key was written to content storage 318 after the cache 332 was most recently updated. Therefore, the value of the key in cache 332, A, is stale with respect to the value of the key in content storage 318, B.

Continuing the example, say that after read request at t=10 seconds, cache management module 330 updates cache 332 with the new value of the key, B. Cache management module 330 provides cache 332 with a new read timestamp of t=10.1 seconds. If, at t=11 seconds, a client makes a request to read the value of the key, cache management module 330 compares the read timestamp of t=10.1 seconds to the UBWAT of t=9.1 seconds. As the UBWAT is before the read timestamp, the value of the key was updated in cache 332 after it was written to content storage 318. Thus, the value of the key in cache 332, B, is not stale with respect to the value of the key in content storage 318, also B. In some embodiments, cache management system 330 may fail in the process of updating cache 332 with the value from content storage 318 (e.g., if cache management system is a server, the server may crash). In these embodiments, the read timestamp of cache 332 also fails to be updated. Thus, when cache management system 330 compares the UBWAT to the read timestamp, the UBWAT will be after the read timestamp, indicating that the value of the key in cache 332 is stale (i.e., it never got updated).

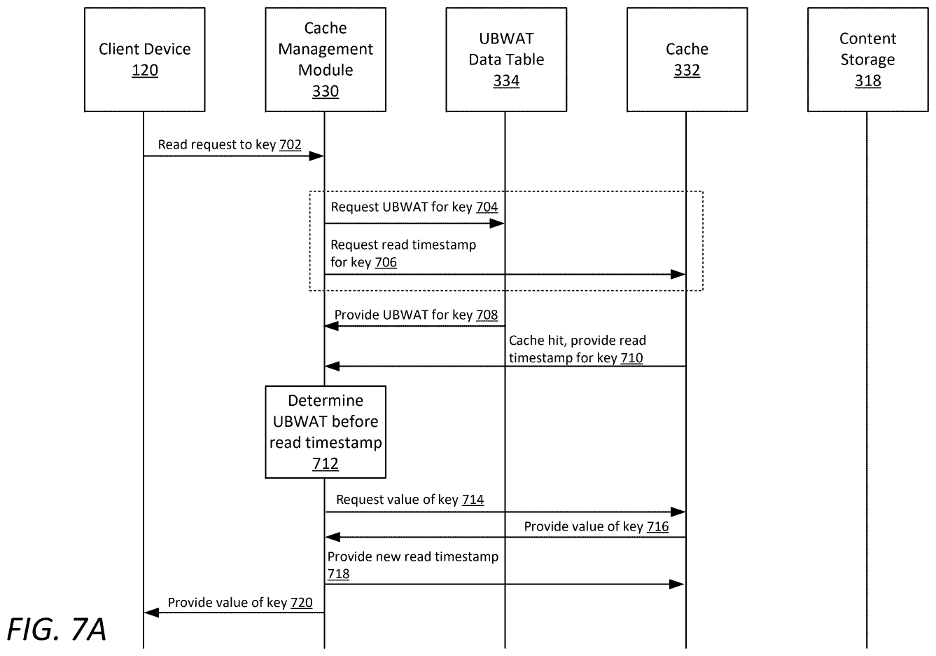

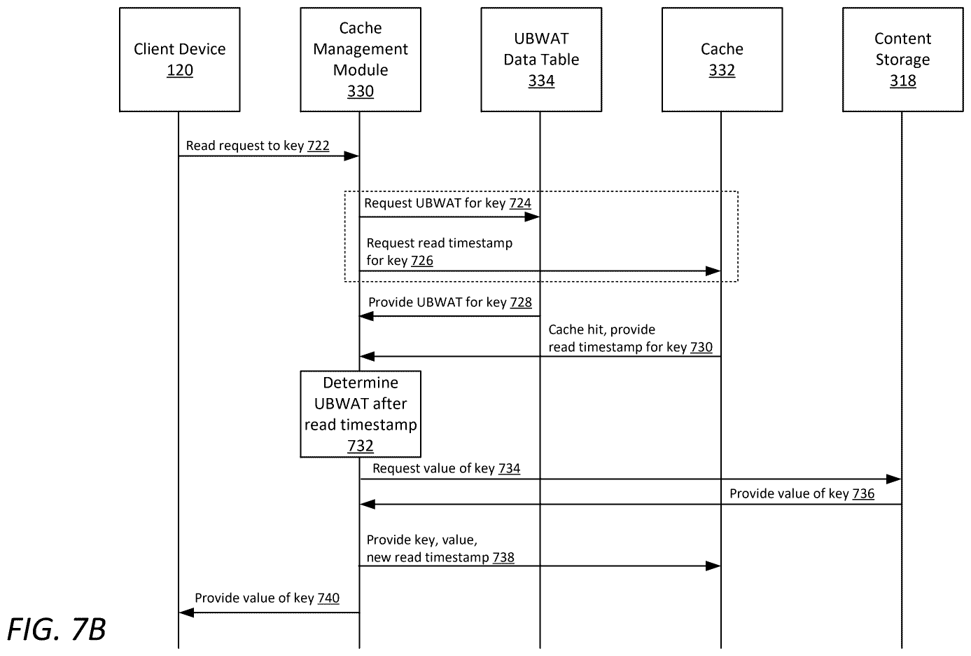

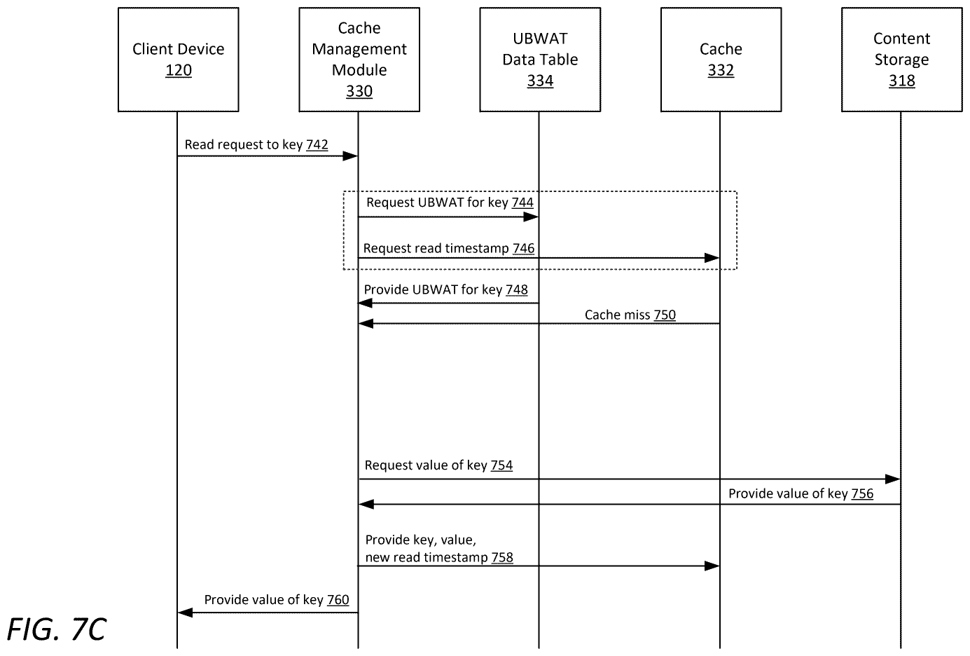

Cache management module 330 retrieves a value of the key from either cache 332 or content storage 318 based on the comparison of the UBWAT and the read timestamp. In response to determining that the value of the key stored in cache 332 is not stale, cache management module 330 retrieves the value of the key from cache 332. Cache management module 330 updates the read timestamp for the key in cache 332 to be the time at which cache management module 330 retrieves the value (i.e., reads the value of the key). In response to determining that the value of the key stored in cache 332 is stale, cache management module 330 retrieves the value of the key from content storage 318. Cache management module 330 updates the value of the key in cache 332 with the value from content storage 318. Cache management module updates the read timestamp of the key in cache 332 to the time at which cache management module 330 retrieves the value (i.e., reads the value of the key). Further details of an example read process are described with respect to FIGS. 7A, 7B, and 7C.

In some embodiments, cache management module 330 attempts to obtain the read timestamp for the key from cache 332 but finds that the key does not exist in the cache (a cache miss). In such embodiments, cache management module 330 retrieves the value of the key from content storage 318 and adds the key-value pair to cache 332 for faster retrieval on a subsequent request.

FIGS. 7A, 7B, and 7C are interaction diagrams illustrating various read processes, in accordance with some embodiments. FIG. 7A shows a read process where cache 332 is not stale with respect to content storage 318. FIG. 7A begins with client device 120 making a read request to read the value of a key 702. In response to receiving the request, cache management module 330 requests an UBWAT for the key 704 from UBWAT table 334 and requests a read timestamp 706 from cache 332. The dotted box around steps 704 and 706 indicates that the steps may happen in parallel. UBWAT data table 334 provides an UBWAT for the key 708. The request hits cache 332, and cache 332 provides a read timestamp for the key 710. Cache management module 330 determines that the UBWAT is before the read timestamp 712, indicating that the value of the key in cache 332 is not stale with respect to the value of the key in content storage 318. Cache management module 330 requests the value of the key 714 from cache 332. Cache 332 provides the value of the key 716. Cache management module 330 provides cache 332 with a new read timestamp 718. Cache management module 330 provides client device 120 with the value of the key 720.

FIG. 7B shows a read process where cache 332 is stale with respect to content storage 318. Like the process shown in FIG. 7A, the process in FIG. 7B begins with cache management module 330 receiving, from client device 120, a read request to read the value of a key 722 in content storage 318. Optionally in parallel, cache management module 330 requests an UBWAT for the key 724 and requests a read timestamp for the key 726.

UBWAT data table 334 provides an UBWAT for the key 728. The request hits cache 332, and cache 332 provides a read timestamp for the key 730. Cache management module 330 determines that the UBWAT is after the read timestamp 732, indicating that the value of the key in cache 332 is stale with respect to the value of the key in content storage 318. Cache management module 330 requests the value of the key 734 from content storage 318. Content storage 318 provides the value of the key 736. Cache management module 330 provides the key, the value of the key, and a new read timestamp 738 to cache 332 for use in responding to subsequent requests. Cache management module 330 provides the value of the key 740 to client device 120.

FIG. 7C shows a read process with a cache miss. The process shown in FIG. 7C is the same as that shown in FIG. 7B minus steps 730 and 732 from FIG. 7B. The process in FIG. 7C begins with cache management module 330 receiving, from client device 120, a read request to read the value of a key 742 in content storage 318. In parallel, cache management module 330 requests an UBWAT for the key 744 and requests a read timestamp for the key 746. UBWAT data table 334 provides an UBWAT for the key 748. The request misses 750 cache 332, indicating that the key is not stored in cache 332. Cache management module 330 thus requests the value of the key 754 from content storage 318. Content storage 318 provides the value of the key 756. Cache management module 330 provides the key, the value of the key, and a new read timestamp 758 to cache 332 for use in responding to subsequent requests. Cache management module 330 provides the value of the key 760 to client device 120.

Returning to the discussion of content management system 100, content management system 100 can also include authenticator module 306, which verifies user credentials, security tokens, API calls, specific client devices, etc., to determine whether access to requested content items is authorized, and is one means for performing this function. Authenticator module 306 can generate one-time use authentication tokens for a user account. Authenticator module 306 assigns an expiration period or date to each authentication token. In addition to sending the authentication tokens to requesting client devices, authenticator module 306 can store generated authentication tokens in authentication token database 320. After receiving a request to validate an authentication token, authenticator module 306 checks authentication token database 320 for a matching authentication token assigned to the user. Once the authenticator module 306 identifies a matching authentication token, authenticator module 306 determines if the matching authentication token is still valid. For example, authenticator module 306 verifies that the authentication token has not expired or was not marked as used or invalid. After validating an authentication token, authenticator module 306 may invalidate the matching authentication token, such as a single-use token. For example, authenticator module 306 can mark the matching authentication token as used or invalid, or delete the matching authentication token from authentication token database 320.

In some embodiments, content management system 100 includes a content item management module 308 for maintaining a content directory that identifies the location of each content item in content storage 318, and allows client applications to request access to content items in the storage 318, and which is one means for performing this function. A content entry in the content directory can also include a content pointer that identifies the location of the content item in content storage 318. For example, the content entry can include a content pointer designating the storage address of the content item in memory. In some embodiments, the content entry includes multiple content pointers that point to multiple locations, each of which contains a portion of the content item.

In addition to a content path and content pointer, a content entry in some configurations also includes user account identifier that identifies the user account that has access to the content item. In some embodiments, multiple user account identifiers can be associated with a single content entry indicating that the content item has shared access by the multiple user accounts.

In some embodiments, content item management module 308 replicates data across multiple nodes. Content management module 308 may assign a node as a leader and other nodes as followers. In response to receiving a request to write data to content storage 318, cache management module 330 writes data to the leader node. The leader node stores the most recent data. Asynchronously, content management module 308 replicates the data stored in the leader node and stores the replicated data in the follower nodes. In response to receiving a request to read data to content storage 318, cache management module 330 may serve the request from the follower nodes. This reduces the demand on the leader node. In some embodiments, cache management module 330 may serve requests from follower nodes if the read timestamp of the data (e.g., read timestamp of the key) is sufficiently old, for example is a greater than a threshold amount of time before the current time. In some embodiments, content management module 308 may choose a new leader node from the follower nodes, for example if the leader node dies or loses connection.

Content item management module 308 may also perform various invariants checks on metadata such as checking state information and timestamps to ensure that a state transition is valid. Content item management module 308 may reject any state transition that is determined to be invalid and allow state transitions that are determined to be valid. In some embodiments, the content management system 100 can include a mail server module 322. The mail server module 322 can send (and receive) collaborative content items to (and from) other client devices using the collaborative content management system 100. The mail server module can also be used to send and receive messages between users in the content management system.

### Collaborative Content Management System

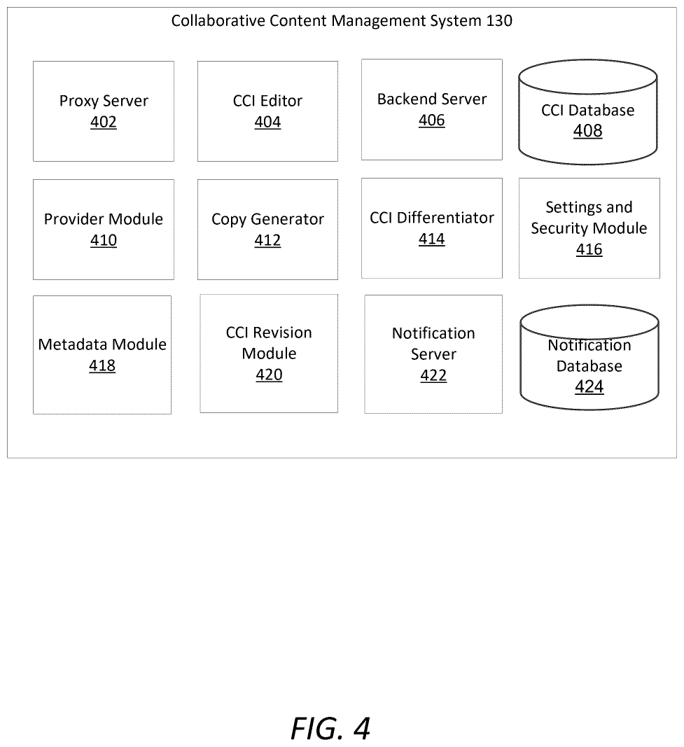

FIG. 4 shows a block diagram of the collaborative content management system 130, according to one embodiment. Collaborative content items can be files that users can create and edit using a collaborative content items editor 270 and can contain collaborative content item elements. Collaborative content item elements may include any type of content such as text; images, animations, videos, audio, or other multi-media; tables; lists; references to external content; programming code; tasks; tags or labels; comments; or any other type of content. Collaborative content item elements can be associated with an author identifier, attributes, interaction information, comments, sharing users, etc. Collaborative content item elements can be stored as database entities, which allows for searching and retrieving the collaborative content items. As with other types of content items, collaborative content items may be shared and synchronized with multiple users and client devices 120, using sharing 310 and synchronization 312 modules of content management system 100. Users operate client devices 120 to create and edit collaborative content items, and to share collaborative content items with other users of client devices 120. Changes to a collaborative content item by one client device 120 are propagated to other client devices 120 of users associated with that collaborative content item. In the embodiment of FIG. 1, collaborative content management system 130 is shown as separate from content management system 100 and can communicate with it to obtain its services. In other embodiments, collaborative content management system 130 is a subsystem of the component of content management system 100 that provides sharing and collaborative services for various types of content items. User account database 316 and authentication token database 320 from content management system 100 are used for accessing collaborative content management system 130 described herein.

Collaborative content management system 130 can include various servers for managing access and edits to collaborative content items and for managing notifications about certain changes made to collaborative content items. Collaborative content management system 130 can include proxy server 402, collaborative content item editor 404, backend server 406, and collaborative content item database 408, access link module 410, copy generator 412, collaborative content item differentiator 414, settings module 416, metadata module 418, revision module 420, notification server 422, and notification database 424. Proxy server 402 handles requests from client applications 200 and passes those requests to the collaborative content item editor 404. Collaborative content item editor 404 manages application-level requests for client applications 200 for editing and creating collaborative content items, and selectively interacts with backend servers 406 for processing lower level processing tasks on collaborative content items, and interfacing with collaborative content items database 408 as needed. Collaborative content items database 408 contains a plurality of database objects representing collaborative content items, comment threads, and comments. Each of the database objects can be associated with a content pointer indicating the location of each object within the CCI database 408. Notification server 422 detects actions performed on collaborative content items that trigger notifications, creates notifications in notification database 424, and sends notifications to client devices.

Client application 200 sends a request relating to a collaborative content item to proxy server 402. Generally, a request indicates the userID (“UID”) of the user, and the collaborativeContentItemID (“NID”) of the collaborative content item, and additional contextual information as appropriate, such as the text of the collaborative content item. When proxy server 402 receives the request, the proxy server 402 passes the request to the collaborative content item editor 404. Proxy server 402 also returns a reference to the identified collaborative content items proxy server 402 to client application 200, so the client application can directly communicate with the collaborative content item editor 404 for future requests. In an alternative embodiment, client application 200 initially communicates directly with a specific collaborative content item editor 404 assigned to the userID.

When collaborative content item editor 404 receives a request, it determines whether the request can be executed directly or by a backend server 406. When the request adds, edits, or otherwise modifies a collaborative content item the request is handled by the collaborative content item editor 404. If the request is directed to a database or index inquiry, the request is executed by a backend server 406. For example, a request from client device 120 to view a collaborative content item or obtain a list of collaborative content items responsive to a search term is processed by backend server 406.

The access module 410 receives a request to provide a collaborative content item to a client device. In one embodiment, the access module generates an access link to the collaborative content item, for instance in response to a request to share the collaborative content item by an author. The access link can be a hyperlink including or associated with the identification information of the CCI (i.e., unique identifier, content pointer, etc.). The hyperlink can also include any type of relevant metadata within the content management system (i.e., author, recipient, time created, etc.). In one embodiment, the access module can also provide the access link to user accounts via the network 110, while in other embodiments the access link can be provided or made accessible to a user account and is accessed through a user account via the client device. In one embodiment, the access link will be a hyperlink to a landing page (e.g., a webpage, a digital store front, an application login, etc.) and activating the hyperlink opens the landing page on a client device. The landing page can allow client devices not associated with a user account to create a user account and access the collaborative content item using the identification information associated with the access link. Additionally, the access link module can insert metadata into the collaborative content item, associate metadata with the collaborative content item, or access metadata associated with the collaborative content item that is requested.

The access module 410 can also provide collaborative content items via other methods. For example, the access module 410 can directly send a collaborative content item to a client device or user account, store a collaborative content item in a database accessible to the client device, interact with any module of the collaborative content management system to provide modified versions of collaborative content items (e.g., the copy generator 412, the CCI differentiator 414, etc.), sending content pointer associated with the collaborative content item, sending metadata associated with the collaborative content item, or any other method of providing collaborative content items between devices in the network. The access module can also provide collaborative content items via a search of the collaborative content item database (i.e., search by a keyword associated with the collaborative content item, the title, or a metadata tag, etc.).

The copy generator 412 can duplicate a collaborative content item. Generally, the copy generator duplicates a collaborative content item when a client device selects an access link associated with the collaborative content item. The copy generator 412 accesses the collaborative content item associated with the access link and creates a derivative copy of the collaborative content item for every request received. The copy generator 412 stores each derivative copy of the collaborative content item in the collaborative content item database 408. Generally, each copy of the collaborative content item that is generated by the copy generator 412 is associated with both the client device from which the request was received, and the user account associated with the client device requesting the copy. When the copy of the collaborative content item is generated, it can create a new unique identifier and content pointer for the copy of the collaborative content item. Additionally, the copy generator 412 can insert metadata into the collaborative content item, associate metadata with the copied collaborative content item, or access metadata associated with the collaborative content item that was requested to be copied.

The collaborative content item differentiator 414 determines the difference between two collaborative content items. In one embodiment, the collaborative content item differentiator 414 determines the difference between two collaborative content items when a client device selects an access hyperlink and accesses a collaborative content item that the client device has previously used the copy generator 412 to create a derivative copy. The content item differentiator can indicate the differences between the content elements of the compared collaborative content items. The collaborative content item differentiator 414 can create a collaborative content item that includes the differences between the two collaborative content items, i.e., a differential collaborative content item. In some embodiments, the collaborative content item differentiator provides the differential collaborative content item to a requesting client device 120. The differentiator 414 can store the differential collaborative content item in the collaborative content item database 408 and generate identification information for the differential collaborative content item. Additionally, the differentiator 414 can insert metadata into the accessed and created collaborative content items, associate metadata with the accessed and created collaborative content item, or access metadata associated with the collaborative content items that were requested to be differentiated.

The settings and security module 416 can manage security during interactions between client devices 120, the content management system 100, and the collaborative content management system 130. Additionally, the settings and security module 416 can manage security during interactions between modules of the collaborative content management system. For example, when a client device 120 attempts to interact within any module of the collaborative content management system 100, the settings and security module 416 can manage the interaction by limiting or disallowing the interaction. Similarly, the settings and security module 416 can limit or disallow interactions between modules of the collaborative content management system 130. Generally, the settings and security module 416 accesses metadata associated with the modules, systems 100 and 130, devices 120, user accounts, and collaborative content items to determine the security actions to take. Security actions can include: requiring authentication of client devices 120 and user accounts, requiring passwords for content items, removing metadata from collaborative content items, preventing collaborative content items from being edited, revised, saved or copied, or any other security similar security action. Additionally, settings and security module can access, add, edit or delete any type of metadata associated with any element of content management system 100, collaborative content management system 130, client devices 120, or collaborative content items.

The metadata module 418 manages metadata within with the collaborative content management system. Generally, metadata can take three forms within the collaborative content management system: internal metadata, external metadata, and device metadata. Internal metadata is metadata within a collaborative content item, external metadata is metadata associated with a CCI but not included or stored within the CCI itself, and device metadata is associated with client devices. At any point the metadata module can manage metadata by changing, adding, or removing metadata.

Some examples of internal metadata can be: identifying information within collaborative content items (e.g., email addresses, names, addresses, phone numbers, social security numbers, account or credit card numbers, etc.); metadata associated with content elements (e.g., location, time created, content element type; content element size; content element duration, etc.); comments associated with content elements (e.g., a comment giving the definition of a word in a collaborative content item and its attribution to the user account that made the comment); or any other metadata that can be contained within a collaborative content item.

Some examples of external metadata can be: content tags indicating categories for the metadata; user accounts associated with a CCI (e.g., author user account, editing user account, accessing user account etc.); historical information (e.g., previous versions, access times, edit times, author times, etc.); security settings; identifying information (e.g., unique identifier, content pointer); collaborative content management system 130 settings; user account settings; or any other metadata that can be associated with the collaborative content item.

Some examples of device metadata can be: device type; device connectivity; device size; device functionality; device sound and display settings; device location; user accounts associated with the device; device security settings; or any other type of metadata that can be associated with a client device 120.

The collaborative content item revision module 420 manages application-level requests for client applications 200 for revising differential collaborative content items and selectively interacts with backend servers 406 for processing lower level processing tasks on collaborative content items, and interfacing with collaborative content items database 408 as needed. The revision module can create a revised collaborative content item that is some combination of the content elements from the differential collaborative content item. The revision module 420 can store the revised collaborative content item in the collaborative content item database or provide the revised collaborative content item to a client device 120. Additionally, the revision module 420 can insert metadata into the accessed and created collaborative content items, associate metadata with the accessed and created collaborative content item, or access metadata associated with the collaborative content items that were requested to be differentiated.

Content management system 100 and collaborative content management system 130 may be implemented using a single computer, or a network of computers, including cloud-based computer implementations. The operations of content management system 100 and collaborative content management system 130 as described herein can be controlled through either hardware or through computer programs installed in computer storage and executed by the processors of such server to perform the functions described herein. These systems include other hardware elements necessary for the operations described here, including network interfaces and protocols, input devices for data entry, and output devices for display, printing, or other presentations of data, but which are not described herein. Similarly, conventional elements, such as firewalls, load balancers, collaborative content items servers, failover servers, network management tools and so forth are not shown so as not to obscure the features of the system. Finally, the functions and operations of content management system 100 and collaborative content management system 130 are sufficiently complex as to require implementation on a computer system, and cannot be performed in the human mind simply by mental steps.

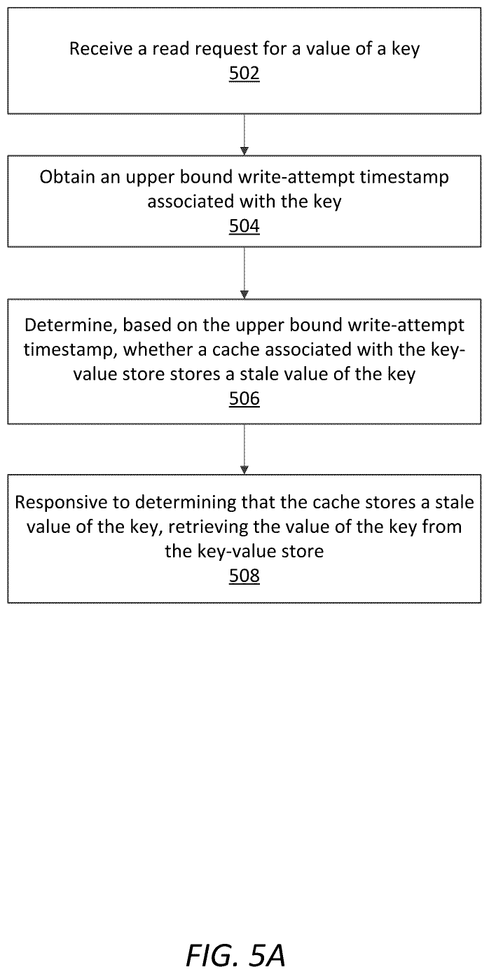

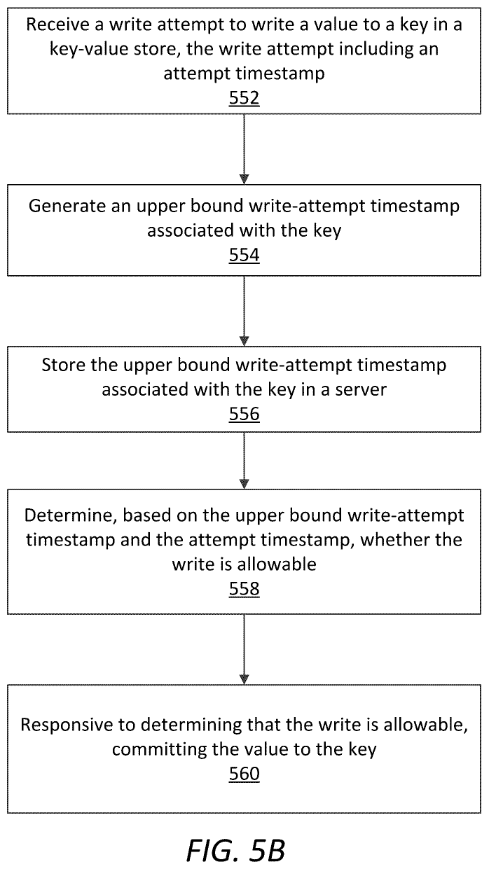

FIG. 5A is a flow chart that illustrates an example process for reading a value of a key from a key-value store using a cache. The process in FIG. 5A begins with content management system 100 receiving 502, from a client, a read request for the value of the key. The key and value may be stored as a key-value pair in a key-value store (e.g., content storage 318) and may be cached in a cache associated with the key value store (e.g., cache 332). The content management system 100 may receive the request from a client (e.g., through client device 120 through communications interface 300 via an API). Content management system 100 obtains 504 an upper bound write attempt timestamp (UBWAT) associated with the key. The upper bound write attempt timestamp tracks an upper bound for the most recent observed write attempt to the key (whether or not that write attempt was successful). Thus, in some embodiments, UBWAT may represent, at any given time, the latest possible time at which the value of the key could have been updated (written to). Content management system 100 may retrieve the UBWAT from a server storing an UBWAT for every key in a key-value store (e.g., UBWAT data table 334).

Content management system 100 determines 506, based on the upper bound write attempt timestamp, whether a cache associated with the key-value store stores a stale value of the key. To make this determination, content management system 100 retrieves a read timestamp for the key from the cache. The read timestamp is a timestamp associated with the value of the key in the cache. The read timestamp may represent the time at which the value of the key was last read from the key-value store and subsequently added to the cache. For example, when content management system 100 makes a request to the cache and gets a cache miss (indicating that the key does not exist in the cache), content management system 100 reads the value of the key from the key-value store. The time at which this read is done is the read timestamp for the key. In some embodiments, the key-value store may provide the read timestamp to content management system 100. In other embodiments, content management system 100 may generate a read timestamp upon retrieval of the value from the key-value store. Content management system 100 may update the read timestamp upon retrieving the value of the key from the key-value store or upon adding the value of the key to cache 332, regardless of whether the value has changed. Content management system 100 compares the UBWAT for the key and the read timestamp for the key. Content management system 100 determines that the UBWAT is after the read timestamp, indicating that the value of the key stored in the cache is stale with respect to the value of the key stored in the key-value store.

In response to determining that the cache stores a stale value of the key, content management system 100 retrieves 508 the value of the key from the key-value store. Content management system 100 provides the value of the key to the client. In response to a cache miss, content management system 100 may add the key-value pair retrieved from the key-value store to the cache for faster retrieval on a subsequent request.

FIG. 5B is a flow chart that illustrates an example process for reading a value of a key from a key-value store using a cache. The process in FIG. 5B begins with content management system 100 receiving 552 receiving, from a client, a write attempt to write the value to the key in a key-value store. The write attempt includes the value to write to the key and an attempt timestamp. The attempt timestamp represents a time at which content management system 100 should complete the write by.

Content management system 100 generates 554 an upper bound write attempt timestamp (UBWAT) for the key. Content management system 100 generates the UBWAT for the key such that the UBWAT is greater than or equal to the timestamp of the write attempt. The timestamp of the write attempt may be different from the attempt timestamp. Content management system 100 may add a buffer to the timestamp of the write attempt and use the buffered timestamp as the UBWAT. Content management system 100 stores 556 the UBWAT for the key in server (e.g., UBWAT data table 334). Content management system 100 determines 558, based on the UBWAT and the attempt timestamp, whether the write attempt is allowable. Content management system 100 compares the UBWAT to the attempt timestamp. If the UBWAT is after the attempt timestamp, content management system 100 determines that the write attempt is allowable. If the UBWAT is after attempt timestamp, content management system 100 determines that the write attempt is not allowable. For example, content management system 100 may receive a write attempt at time t=20 seconds with an attempt timestamp of t=25 seconds. Content management system 100 may generate an UBWAT to be t=20.1 seconds. Content management system 100 determines that the attempt timestamp is after the UBWAT, indicating that the write attempt is not allowable. In another example, content management system 100 may receive a write attempt at time t=20 seconds with an attempt timestamp of t=20.05 seconds. Content management system 100 may generate an UBWAT to be t=20.1 seconds. Content management system 100 determines that the UBWAT is after the attempt timestamp, indicating that the write attempt is allowable.

In response to determining that the attempt is allowable, content management system 100 commits 560 the value to the key in the key-value store (e.g., content store 318). In response to determining that the attempt is not allowable, content management system 100 fails the write and does not commit the value to the key in the key-value store. Content management system 100 may provide the client with a response indicating that the write was unsuccessful.

### Additional Considerations

Reference in the specification to “one embodiment” or to “an embodiment” means that a particular feature, structure, or characteristic described in connection with the embodiments is included in at least one embodiment. The appearances of the phrase “in one embodiment” in various places in the specification are not necessarily all referring to the same embodiment.

In this description, the term “module” refers to a physical computer structure of computational logic for providing the specified functionality. A module can be implemented in hardware, firmware, and/or software. In regard to software implementation of modules, it is understood by those of skill in the art that a module comprises a block of code that contains the data structure, methods, classes, header and other code objects appropriate to execute the described functionality. Depending on the specific implementation language, a module may be a package, a class, or a component. It will be understood that any computer programming language may support equivalent structures using a different terminology than “module.”

It will be understood that the named modules described herein represent one embodiment of such modules, and other embodiments may include other modules. In addition, other embodiments may lack modules described herein and/or distribute the described functionality among the modules in a different manner. Additionally, the functionalities attributed to more than one module can be incorporated into a single module. Where the modules described herein are implemented as software, the module can be implemented as a standalone program, but can also be implemented through other means, for example as part of a larger program, as a plurality of separate programs, or as one or more statically or dynamically linked libraries. In any of these software implementations, the modules are stored on the computer readable persistent storage devices of a system, loaded into memory, and executed by the one or more processors of the system's computers.

The operations herein may also be performed by an apparatus. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including optical disks, CD-ROMs, read-only memories (ROMs), random access memories (RAMs), magnetic or optical cards, or any type of media suitable for storing electronic instructions, and each coupled to a computer system bus. Furthermore, the computers referred to in the specification may include a single processor or may be architectures employing multiple processor designs for increased computing capability.

The algorithms presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It will be appreciated that a variety of programming languages may be used to implement the teachings of the present invention as described herein, and any references above to specific languages are provided for disclosure of enablement and best mode of the present invention.

While the invention has been particularly shown and described with reference to a preferred embodiment and several alternate embodiments, it will be understood by persons skilled in the relevant art that various changes in form and details can be made therein without departing from the spirit and scope of the invention.

As used herein, the word “or” refers to any possible permutation of a set of items. Moreover, claim language reciting ‘at least one of’ an element or another element refers to any possible permutation of the set of elements.

Although this description includes a variety of examples and other information to explain aspects within the scope of the appended claims, no limitation of the claims should be implied based on particular features or arrangements these examples. This disclosure includes specific embodiments and implementations for illustration, but various modifications can be made without deviating from the scope of the embodiments and implementations. For example, functionality can be distributed differently or performed in components other than those identified herein. This disclosure includes the described features as non-exclusive examples of systems components, physical and logical structures, and methods within its scope.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A method of reading a value of a key, the method comprising:
receiving, from a client, a read request for the value of the key;
obtaining, from a server, for every key in a key-value store, an upper bound write attempt timestamp associated with the key;
determining, based on the upper bound write attempt timestamp associated with the key, whether a cache associated with the key-value store stores a stale value of the key; and
responsive to determining that the cache stores a stale value of the key, retrieving the value of the key from the key-value store.

2. The method of claim 1, wherein determining whether the cache associated with the key-value store stores a stale value of the key comprises:
obtaining, from a cache associated with the key-value store, a read timestamp associated with the key; and
determining that the upper bound write attempt timestamp is after the read timestamp.

3. The method of claim 1 further comprising responsive to determining that the cache stores a stale value of the key:
retrieving a new read timestamp associated with the key from the key-value store; and
updating the cache with the key, the value, and the new read timestamp.

4. The method of claim 1, wherein determining whether the cache associated with the key-value store stores a stale value of the key is responsive to receiving a response from the cache, and wherein responsive to not receiving a response from the cache retrieving the value of the key from the key-value store.

5. The method of claim 1, further comprising:
receiving, from a client, a write request for a new value of the key and a write attempt timestamp associated with the write request;
updating the server with the key and the write attempt timestamp; and
updating the key-value store with the key and the new value.

6. The method of claim 5, wherein the upper bound write attempt timestamp is greater than or equal to the write attempt timestamp.

7. The method of claim 1, wherein the read timestamp associated with the key is greater than or equal to a commit timestamp associated with the key, wherein the commit timestamp represents a time at which the key-value store is updated with the key and the new value.

8. The method of claim 1, wherein the key-value store is a distributed key-value store storing data as key-value pairs in tables distributed across multiple nodes.

9. A non-transitory computer-readable storage medium storing executable computer instructions that, when executed by one or more processors, cause the one or more processors to perform operations comprising:
receiving, from a client, a read request for the value of the key;
obtaining, from a server, for every key in a key-value store, an upper bound write attempt timestamp associated with the key;
determining, based on the upper bound write attempt timestamp, that a cache associated with the key-value store stores a stale value of the key; and
retrieving the value of the key from the key-value store.

10. The non-transitory computer-readable storage medium of claim 9, wherein determining that the cache associated with the key-value store stores a stale value of the key comprises:
obtaining, from a cache associated with the key-value store, a read timestamp associated with the key; and
determining that the upper bound write attempt timestamp is after the read timestamp.

11. The non-transitory computer-readable storage medium of claim 9, the operations further comprising, responsive to determining that the cache associated with the key-value store stores a stale value of the key:
retrieving a new read timestamp associated with the key from the key-value store, and
updating the cache with the key, the value, and the new read timestamp.

12. The non-transitory computer-readable storage medium of claim 9, wherein determining that the cache associated with the key-value store stores a stale value of the key is performed responsive to receiving a response from the cache, and wherein the operations further comprise, responsive to not receiving a response from the cache, retrieving the value of the key from the key-value store.

13. The non-transitory computer-readable storage medium of claim 9, the operations further comprising:
receiving, from a client, a write request for a new value of the key and a write attempt timestamp associated with the write request;
updating the server with the key and the write attempt timestamp; and
updating the key-value store with the key and the new value.

14. The non-transitory computer-readable storage medium of claim 13, wherein the upper bound write attempt timestamp is greater than or equal to the write attempt timestamp.

15. The non-transitory computer-readable storage medium of claim 9, wherein the read timestamp associated with the key is greater than or equal to a commit timestamp associated with the key, wherein the commit timestamp represents a time at which the key-value store is updated with the key and the new value.

16. The non-transitory computer-readable storage medium of claim 9, wherein the key-value store is a distributed key-value store storing data as key-value pairs in tables distributed across multiple nodes.

17. A method of writing a value to a key, the method comprising:
receiving, from a client, a write attempt to write the value to the key in a key-value store, the write attempt including an attempt timestamp;
generating an upper bound write attempt timestamp, the upper bound write attempt timestamp associated with the key;
storing the upper bound write attempt timestamp for the key in a server;
determining, based on the upper bound write attempt timestamp and the attempt timestamp, whether the write attempt is allowable; and
responsive to determining that the attempt is allowable, committing the value to the key in the key-value store.

18. The method of claim 17, wherein determining whether the write attempt is allowable comprises determining that the upper bound write attempt timestamp is after the attempt timestamp.

19. The method of claim 17, further comprising:
receiving, from a client, a read request for the value of the key;
obtaining, from the server, the upper bound write attempt timestamp associated with the key;
determining, based on the upper bound write attempt timestamp associated with the key, whether a cache associated with the key-value store stores a stale value of the key; and
responsive to determining that the cache stores a stale value of the key, retrieving the value of the key from the key-value store.

20. The method of claim 17, wherein the key-value store is a distributed key-value store storing data as key-value pairs in tables distributed across multiple nodes.
